(19) United States
(12) Patent Application Publication
(10) Pub. No.: US 2023/0321535 A1
(43) Pub. Date: Oct. 12, 2023

(54) COORDINATE AXIS DISPLAY METHOD AND APPARATUS APPLIED TO VIRTUAL ENVIRONMENTS, TERMINAL, AND MEDIUM

(71) Applicant: TENCENT TECHNOLOGY (SHENZHEN) COMPANY LIMITED, Shenzhen (CN)

(72) Inventor: Jieqi XIE, Shenzhen (CN)

(21) Appl. No.: 18/333,692

(22) Filed: Jun. 13, 2023

Related U.S. Application Data
(63) Continuation of application No. PCT/CN2022/124102, filed on Oct. 9, 2022.

(30) Foreign Application Priority Data
Oct. 26, 2021 (CN) 202111248536.1
Dec. 30, 2021 (CN) 202111652782.3

(51) Int. Cl. A63F 13/525; G06T 19/00

(52) U.S. Cl. CPC A63F 13/525; G06T 19/003; G06T 2210/62; G06T 2219/004

(57) ABSTRACT

A coordinate axis display method includes: displaying a virtual environment picture; displaying a first coordinate axis corresponding to a first virtual environment at a first position in the virtual environment picture, and displaying a second coordinate axis corresponding to a second virtual environment at a second position in the virtual environment picture, wherein a virtual object is located in the first virtual environment, the second virtual environment is a virtual environment other than the first virtual environment, and the coordinate axes carry markers in the virtual environments, a marker indicating a candidate destination of the virtual object where a task can be accomplished; and updating the first coordinate axis and the second coordinate axis as the virtual object moves from the first virtual environment to the second virtual environment.

### CROSS-REFERENCES TO RELATED APPLICATIONS

This application is a continuation application of PCT Patent Application No. PCT/CN2022/124102, entitled “COORDINATE AXIS DISPLAY METHOD AND APPARATUS USED IN VIRTUAL ENVIRONMENT, TERMINAL AND MEDIUM” and filed on Oct. 9, 2022, which claims priority to Chinese Patent Application No. 202111248536.1, entitled “COORDINATE AXIS DISPLAY METHOD AND APPARATUS APPLIED TO VIRTUAL ENVIRONMENTS, TERMINAL, AND MEDIUM” filed on Oct. 26, 2021, and to Chinese Patent Application No. 202111652782.3, entitled “COORDINATE AXIS DISPLAY METHOD AND APPARATUS APPLIED TO VIRTUAL ENVIRONMENTS, TERMINAL, AND MEDIUM” filed on Dec. 30, 2021, the entire contents of both of which are incorporated herein by reference.

### FIELD OF THE TECHNOLOGY

Embodiments of the present disclosure relate to the field of human-computer interaction, and in particular, to a coordinate axis display method and apparatus applied to virtual environments, a terminal, and a medium.

### BACKGROUND

Adventure games are games in which a user controls a virtual object to explore different virtual environments. There are different markers in different virtual environments in the games. The user may control the virtual object to move toward the markers between different virtual environments, and the user may obtain corresponding rewards by completing tasks corresponding to the markers, such as level increase of the virtual object and obtaining of virtual props.

In the related art, positions of the markers in different virtual environments may be indicated in a virtual environment picture . On one hand, since there are excessive markers, the markers may overlap in display, thereby blocking some markers and disabling the user to determine whether there is a marker in the direction of the current position of the virtual object. On the other hand, when the user moves the cursor to a marker, it cannot be determined whether the marker is in the virtual environment where the virtual object is located, and a specific position of the marker still cannot be determined.

### SUMMARY

Embodiments of the present disclosure provide a coordinate axis display method and apparatus applied to virtual environments, a terminal, and a medium. By distinguishing coordinate axes and markers corresponding to different virtual environments, the influence on selection of the markers caused by overlapping of the excessive markers on the coordinate axes is avoided, and a user can also conveniently determine specific positions of the markers. The technical solutions are as follows.

According to an aspect, embodiments of the present disclosure provide a coordinate axis display method applied to virtual environments. The method is performed by a terminal. The method includes: displaying a virtual environment picture; displaying a first coordinate axis corresponding to a first virtual environment at a first position in the virtual environment picture, and displaying a second coordinate axis corresponding to a second virtual environment at a second position in the virtual environment picture, wherein a virtual object is located in the first virtual environment, the second virtual environment is a virtual environment other than the first virtual environment, and the coordinate axes carry markers in the virtual environments, a marker indicating a candidate destination of the virtual object where a task can be accomplished; and updating the first coordinate axis and the second coordinate axis as the virtual object moves from the first virtual environment to the second virtual environment.

According to another aspect, embodiments of the present disclosure provide a coordinate axis display apparatus applied to virtual environments. The apparatus includes: a display module, configured to display a virtual environment picture, the display module being configured to display a first coordinate axis corresponding to a first virtual environment at a first position in the virtual environment picture, and display a second coordinate axis corresponding to a second virtual environment at a second position in the virtual environment picture, wherein a virtual object is located in the first virtual environment, the second virtual environment is a virtual environment other than the first virtual environment, and the coordinate axes carry markers in the virtual environments, a marker indicating a candidate destination of the virtual object where a task can be accomplished; and an update module, configured to update the first coordinate axis and the second coordinate axis as the virtual object moves from the first virtual environment to the second virtual environment.

According to another aspect, embodiments of the present disclosure provide a terminal. The terminal includes at least one processor and at least one memory. The memory stores at least one instruction. The at least one instruction is loaded and executed by the at least one processor to implement the coordinate axis control method applied to virtual environments in the foregoing aspect.

According to another aspect, embodiments of the present disclosure provide a non-transitory computer-readable storage medium. The computer-readable storage medium stores at least one instruction. The at least one instruction is loaded and executed by at least one processor to implement the coordinate axis control method applied to virtual environments in the foregoing aspect.

In the embodiments of the present disclosure, a coordinate axis (first coordinate axis) corresponding to a first virtual environment where a virtual object is located and a marker on the coordinate axis are displayed at a first position in a virtual environment picture, and a coordinate axis (second coordinate axis) corresponding to a second virtual environment and a marker on the coordinate axis are displayed at a second position. The second virtual environment is a virtual environment other than the first virtual environment. The coordinate axes at the first position and the second position are updated as the virtual object moves from the first virtual environment to the second virtual environment. The coordinate axes and the markers of different virtual environments are displayed at the first position and the second position respectively, so as to avoid interference on user determination for the markers due to overlapping of the markers, displayed on a coordinate axis, in all the virtual environments. In addition, a user may also determine specific positions of the markers through the marker on the coordinate axis at the first position and the marker on the coordinate axis at the second position, so as to control, using a reasonable policy, the virtual object to move to the markers to accomplish a task.

By distinguishing the coordinate axes corresponding to different virtual environments and the markers in different virtual environments, the user is enabled to determine the specific positions of the markers in the game process and then control, using the reasonable policy, the virtual object to move to the markers to accomplish the task, thereby enriching the user experience and improving the user efficiency in accomplishing the task.

### BRIEF DESCRIPTION OF THE DRAWINGS

FIG. 1 shows a schematic diagram of a virtual environment according to an exemplary embodiment of the present disclosure.

FIG. 2 shows a schematic diagram of an implementation environment according to an exemplary embodiment of the present disclosure.

FIG. 3 shows a flowchart of a coordinate axis display method applied to virtual environments according to an exemplary embodiment of the present disclosure.

FIG. 4 shows a schematic interface diagram of a virtual environment picture according to an exemplary embodiment of the present disclosure.

FIG. 5 shows a schematic diagram of a first coordinate axis and a second coordinate axis according to an exemplary embodiment of the present disclosure.

FIG. 6 shows a flowchart of a coordinate axis display method applied to virtual environments according to another exemplary embodiment of the present disclosure.

FIG. 7 shows a schematic interface diagram of a coordinate axis display method applied to virtual environments according to an exemplary embodiment of the present disclosure.

FIG. 8 shows a flowchart of a coordinate axis display method applied to virtual environments according to another exemplary embodiment of the present disclosure.

FIG. 9 shows a schematic interface diagram of a coordinate axis display method applied to virtual environments according to another exemplary embodiment of the present disclosure.

FIG. 10 shows a flowchart of a coordinate axis display method applied to virtual environments according to another exemplary embodiment of the present disclosure.

FIG. 11 shows a flowchart of a coordinate axis display method applied to virtual environments according to another exemplary embodiment of the present disclosure.

FIG. 12 is a structural block diagram of a coordinate axis display apparatus applied to virtual environments according to an exemplary embodiment of the present disclosure.

FIG. 13 shows a structural block diagram of a terminal according to an exemplary embodiment of the present disclosure.

### DESCRIPTION OF EMBODIMENTS

To make the objects, technical solutions, and advantages of the present disclosure clearer, the following further describes implementations of the present disclosure in detail with reference to the accompanying drawings.

First, the nouns involved in the embodiments of the present disclosure are described:

Virtual Environment: The virtual environment is a virtual environment displayed (or provided) when an application is run on a terminal. The virtual environment may be a simulated environment of a real world, a semi-simulated semi-fictional environment, or a purely fictional environment. The virtual environment may be any one of a two-dimensional virtual environment, a 2.5-dimensional virtual environment, and a three-dimensional virtual environment. The present disclosure is not limited thereto. The following embodiments are exemplified with the virtual environment being a three-dimensional virtual environment.

In addition, there are multiple virtual environments in the embodiments of the present disclosure. In some embodiments, the virtual environment may be divided into an entity-type virtual environment and a space-type virtual environment. The entity-type virtual environment refers to a virtual environment existing in the form of an entity, such as a planet, a space station, or a building. The embodiments of the present disclosure are not limited thereto. The space-type virtual environment refers to a virtual environment existing in the form of a non-entity, and is usually located between entity-type virtual environments, such as space located between planets or space stations, a road located between buildings, or an open space. The specific types of the entity-type virtual environment and the space-type virtual environment are not limited in the embodiments of the present disclosure.

In one embodiment, a user may control a virtual object to move in the same virtual environment. When the virtual object moves in the same virtual environment, the virtual object may move directly, for example, by walking, running, jumping, and the like, without using a virtual vehicle. In another embodiment, the virtual object may move in different virtual environments. When the virtual object moves in different virtual environments, the virtual vehicle is required. In some embodiments, the virtual object may move from the entity-type virtual environment to the space-type virtual environment or from the space-type virtual environment to the entity-type virtual environment.

Certainly, in other embodiments, the virtual vehicle used when moving in the same virtual environment is different from the virtual vehicle used when moving between virtual environments. For example, the virtual vehicle used when moving in the same virtual environment is a virtual automobile, and the virtual vehicle used when moving between virtual environments is a virtual airship.

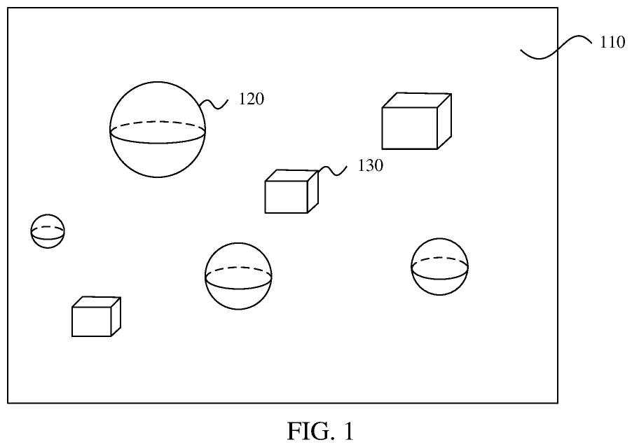

In one embodiment, the virtual object is required to pass through the space-type virtual environment when moving from the current entity-type virtual environment to another entity-type virtual environment. FIG. 1 exemplarily shows a schematic diagram of a virtual environment according to an embodiment of the present disclosure. The virtual environment includes a planet 120, a space station 130 (entity-type virtual environment), and a space 110 (space-type virtual environment). There may be only one space 110, but more planets 120 and space stations 130. In some embodiments, the planet 120 may be Mars, Saturn, Jupiter, or another virtual planet. This embodiment of the present disclosure is not limited thereto. In a game, in some embodiments, a user may control a virtual object to move between the entity-type virtual environments, and the virtual object is required to pass through the space-type virtual environment as moving from the current entity-type virtual environment to another entity-type virtual environment. Exemplarily, the virtual object is currently located in the planet 120. As the user controls the virtual object to move from the planet 120 to the space station 130, the virtual object is required to pass through the space 110. In some embodiments, the user may also control the virtual object to move between the entity-type virtual environment and the space-type virtual environment. Exemplarily, the virtual object is currently located in the space 110, and the user may control the virtual object to move from the space 110 to the planet 120 to the space station 130. Or, the virtual object is currently located in the planet 120 or the space station 130, and the user may control the virtual object to move from the planet 120 or the space station 130 to the space 110.

In addition, a marker is contained in either the entity-type or space-type virtual environment. The marker is configured to indicate that a task exists at a certain position in the virtual environment. The user may control the virtual object to move toward the marker to accomplish the task. In some embodiments, the task may be an item collection task, a combat task, a construction task (construction site), or the like. The marker may be automatically generated in a game process or marked on a virtual map by the user before entering the game.

Virtual Object: The virtual object is a movable object in the virtual environment. The movable object may be a virtual person, a virtual animal, or an animated person, such as a person or an animal displayed in a three-dimensional virtual environment. In some embodiments, the virtual object is a three-dimensional stereo model created based on an animated skeleton technology. Each virtual object has a corresponding shape and volume in the three-dimensional virtual environment, and occupies a portion of space in the three-dimensional virtual environment.

Adventure Game: In the game, the user may control the virtual object to explore in different virtual environments, and obtain rewards by completing corresponding tasks, such as level increase of the virtual object, obtaining of virtual props, and level increase of the virtual props. In some embodiments, the user may control the virtual object to move from the current virtual environment to another virtual environment through the virtual props so as to accomplish the corresponding tasks.

Virtual Prop: The virtual prop is a prop available by the virtual object in the virtual environment. In some embodiments, the virtual prop may be a virtual vehicle capable of assisting the virtual object in moving between different virtual environments, such as an airship, an airplane, or a speedboat. In some embodiments, the virtual prop, such as an attacking virtual prop, a casting virtual prop, or a defending virtual prop, may also be configured to help the virtual object accomplish tasks and defend against attacks.

The method provided in the present disclosure may be applied to a virtual reality application, a three-dimensional map program, a first/third person shooting game, a multiplayer online battle arena (MOBA) game, a massive multiplayer online game (MMOG), a massive multiplayer online role-playing game (MMORPG), and the like. The following embodiment is exemplified with applications in games.

A game based on virtual environments is often composed of one or more maps of a game world. The virtual environments in the game simulate real world scenes. A user may manipulate a virtual object in the game to perform various activities in the virtual environments, such as purchasing items such as props, and interacting with other virtual characters. The other virtual characters are virtual characters controlled by other users. In the game of this embodiment of the present disclosure, there are multiple virtual environments, and the user may control the virtual object to move to different virtual environments for exploration, mainly to find markers and accomplish corresponding tasks.

In a game process, a coordinate axis is displayed in a virtual environment picture. The coordinate axis indicates markers. The markers represent tasks existing in the virtual environments. Since there are multiple virtual environments and the markers existing in all the virtual environments are displayed on the coordinate axis, the markers on the coordinate axis may overlap, thereby interfering with the user selection of the markers. In addition, corresponding markers are also displayed in the virtual environment picture, which correspond to the markers on the coordinate axis one by one. As the virtual object is closer to the marker, an icon of the marker in the virtual environment is larger, and as the virtual object is farther away from the marker, the icon of the marker in the virtual environment is smaller. The user may determine the distance between the virtual object and the marker by the icon size of the marker in the virtual environment. In addition, when the user moves a cursor to the marker, the virtual environment picture will display the distance between the virtual object and the marker, but it is uncertain whether the marker is located in the virtual environment where the virtual object is currently located or another virtual environment. Therefore, the user cannot select a reasonable policy to control the virtual object to move to the marker. For example, the user moves the cursor to a marker to view that the distance between the virtual object and the marker is 1030 kilometers (km), but it cannot be determined whether the marker is in the virtual environment where the virtual object is currently located. Therefore, the user first controls the virtual object to move to the marker by running. However, after a period of time, the virtual object still does not reach the marker. The user controls the virtual object to return to search for an airship, and the virtual object moves toward the marker using the airship, thereby increasing time for the user to search for the marker.

In order to avoid interference on user determination for the markers and accurate determination of specific positions of the markers due to overlapping of the markers, displayed on a coordinate axis, in all the virtual environments, and to improve the participation of players in the game, the coordinate axes of different virtual environments and the markers in different virtual environments are distinguished in this embodiment of the present disclosure. A coordinate axis (first coordinate axis) corresponding to a first virtual environment where a virtual object is located and a marker on the coordinate axis are displayed at a first position in a virtual environment picture, and a coordinate axis (second coordinate axis) corresponding to a virtual environment other than the first virtual environment and a marker on the coordinate axis are displayed at a second position. In addition, as the virtual object moves between the first virtual environment and the second virtual environment, the coordinate axes at the first position and the second position are also changed. In comparison with the related art, interference on user determination for markers due to overlapping of the markers all displayed on one coordinate axis is avoided. In addition, the user may also determine the positions of specific markers, so as to control, using a reasonable policy, the virtual object to move toward the markers and accomplish corresponding tasks.

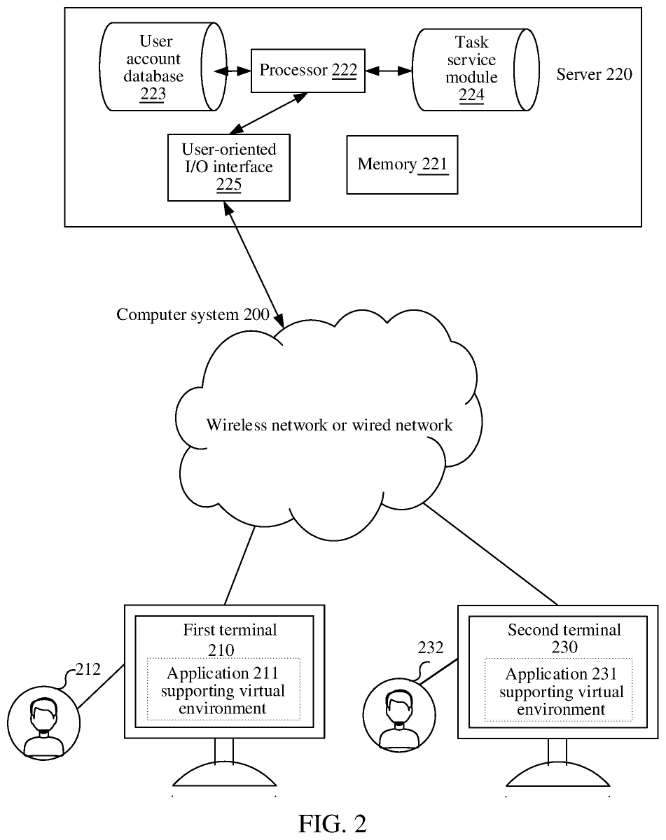

FIG. 2 shows a schematic diagram of an implementation environment according to an embodiment of the present disclosure. The implementation environment may include: a first terminal 210, a server 220, and a second terminal 230.

An application 211 supporting a virtual environment is installed and run in the first terminal 210. The application 211 may be a multiplayer online program. When the first terminal runs the application 211, a user interface of the application 211 is displayed on a screen of the first terminal 210. The application 211 may be any one of a MOBA game, a shooting game, a simulation game (SLG), and an adventure game. In this embodiment, the application 211 is exemplified by being an adventure game. The first terminal 210 is a terminal used by a first user 212. The first user 212 uses the first terminal 210 to control activities of a first virtual object located in a virtual environment. The first virtual object may be referred to as a master virtual object of the first user 212. The activities of the first virtual object include, but are not limited to, at least one of adjusting body posture, crawling, walking, running, riding, flying, jumping, driving, picking up, shooting, attacking, throwing, and skill casting. Exemplarily, the first virtual object is a first virtual person, such as a simulated person or an animated person.

An application 231 supporting a virtual environment is installed and run in the second terminal 230. The application 231 may be a multiplayer online program. When the second terminal 230 runs the application 231, a user interface of the application 231 is displayed on a screen of the second terminal 230. The client may be any one of a MOBA game, a shooting game, a SLG, and an adventure game. In this embodiment, the application 231 is exemplified by being an adventure game. The second terminal 230 is a terminal used by a second user 232. The second user 232 uses the second terminal 230 to control activities of a second virtual object located in the virtual environment. The second virtual object may be referred to as a main control virtual character of the second user 232. Exemplarily, the second virtual object is a second virtual person, such as a simulated person or an animated person.

In some embodiments, the first virtual object and the second virtual object are located in the same virtual world or different virtual worlds. In some embodiments, the first virtual object and the second virtual object may explore and accomplish corresponding tasks in the virtual environment respectively. In some embodiments, the first virtual object and the second virtual object may be grouped together to explore and accomplish corresponding tasks in the virtual environment respectively. In some embodiments,

In some embodiments, the applications installed on the first terminal 210 and the second terminal 230 are the same, or the applications installed on the two terminals are the same type of applications on different operating system platforms (Windows or IOS). The first terminal 210 may generally refer to one of multiple terminals, and the second terminal 230 may generally refer to another of the multiple terminals. This embodiment is exemplified only by the first terminal 210 and the second terminal 230. The first terminal 210 and the second terminal 230 have the same or different device types. The device types include: at least one of a smartphone, a tablet computer, an e-book reader, a moving picture experts group audio layer III (MP3) player, a moving picture experts group audio layer IV (MP4) player, a laptop computer, and a desktop computer.

Only two terminals are shown in FIG. 2. However, in different embodiments, there are multiple other terminals having access to the server 220. In some embodiments, there are also one or more terminals corresponding to a developer. A development and editing platform for an application supporting a virtual environment is installed on the terminal. The developer may edit and update the application on the terminal, and transmit an updated application installation package to the server 220 through a wired or wireless network. The first terminal 210 and the second terminal 230 may download the application installation package from the server 220 to implement the update of the application.

The first terminal 210, the second terminal 230, and the other terminals are connected to the server 220 through the wireless network or the wired network.

The server 220 includes at least one of a server, a server cluster composed of multiple servers, a cloud computing platform, and a virtualization center. The server 220 is configured to provide a background service for the application supporting the three-dimensional virtual environment. In some embodiments, the server 220 undertakes primary computing tasks, and the terminal undertakes secondary computing tasks. Or, the server 220 undertakes secondary computing tasks, and the terminal undertakes primary computing tasks. Or, the server 220 and the terminal perform cooperative computing using a distributed computing architecture.

In a schematic example, the server 220 includes a memory 221, a processor 222, a user account database 223, a task service module 224, and a user-oriented input/output (I/O) interface 225. The processor 222 is configured to load an instruction stored in the server 220 and process data in the user account database 223 and the task service module 224. The user account database 223 is configured to store data of user accounts used by the first terminal 210, the second terminal 230, and the other terminals, such as avatars of the user accounts, nicknames of the user accounts, levels of the user accounts, and service regions where the user accounts are located. The task service module 224 is configured to provide multiple tasks for users to explore. The user-oriented I/O interface 225 is configured to communicate data with the first terminal 210 and/or the second terminal 230 through the wireless network or the wired network. In addition, in the various embodiments described below, the virtual object may be controlled independently by the terminal, independently by the server, or cooperatively by the terminal and the server. The embodiments of the present disclosure are not limited thereto. For the sake of convenience, the following embodiments will be described with a terminal controlling a virtual object. In addition, in the various embodiments described below, the virtual object may be controlled independently by the terminal, independently by the server, or cooperatively by the terminal and the server. The embodiments of the present disclosure are not limited thereto. For the sake of convenience, the following embodiments will be described with a terminal controlling a virtual object.

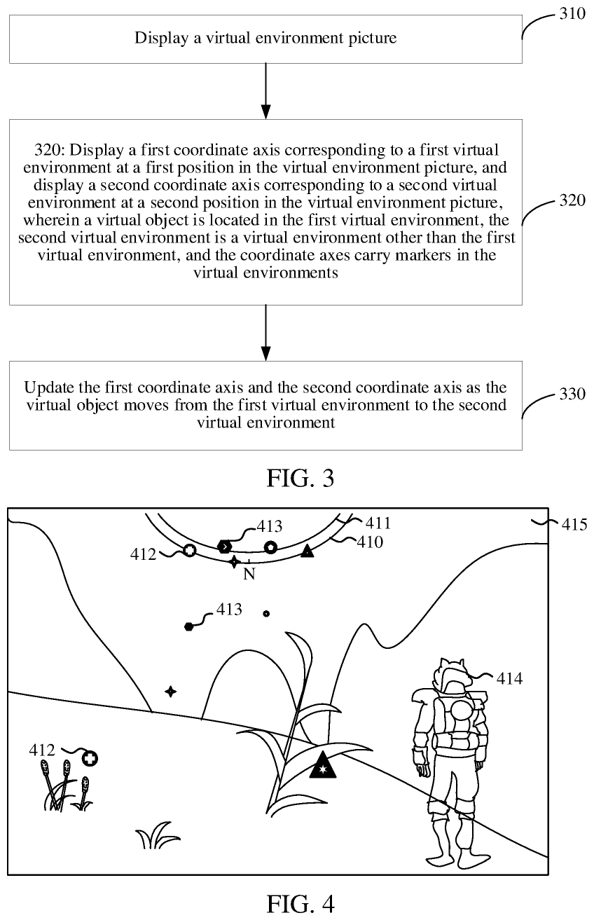

FIG. 3 shows a flowchart of a coordinate axis display method applied to virtual environments according to an exemplary embodiment of the present disclosure. This embodiment of the present disclosure is described with the method being applied to the first terminal 210 or the second terminal 230 in the implementation environment shown in FIG. 2 or other terminals in the implementation environment. The method includes the following steps:

Step 310: Display a virtual environment picture.

A terminal used by a user runs an application supporting a virtual environment. When the user runs the application, a display screen of the terminal correspondingly displays a picture when using the application. The picture is a virtual environment picture. In some embodiments, the virtual environment picture is a picture in which the virtual environment is viewed from a perspective of a virtual object. The perspective refers to a viewing angle when viewing in the virtual environment at a first person perspective or a third person perspective of the virtual object. In some embodiments, in this embodiment of the present disclosure, the perspective is an angle when the virtual object is viewed through a camera model in the virtual environment.

In some embodiments, the camera model automatically follows the virtual object in the virtual environment. That is, when the position of the virtual object in the virtual environment is changed, the camera model is simultaneously changed following the position of the virtual object in the virtual environment, and the camera model is always within a preset distance range of the virtual object in the virtual environment. In some embodiments, relative positions of the camera model and the virtual object are not changed during the automatic following process.

The camera model refers to a three-dimensional model located around the virtual object in the virtual environment. When the first person perspective is adopted, the camera model is located near or at the head of the virtual object. When the third person perspective is adopted, the camera model may be located behind the virtual object and bound with the virtual object, and may also be located at any position at a preset distance from the virtual object. The virtual object located in the virtual environment may be viewed at different angles by the camera model. In some embodiments, the camera model is located behind the virtual object (such as the head and shoulder of a virtual person) when the third person perspective is a first person over-shoulder perspective. In some embodiments, in addition to the first person perspective and the third person perspective, the perspective also includes other perspectives such as an overhead perspective. The camera model may be located above the head of the virtual object when the overhead perspective is adopted. The overhead perspective is a perspective for viewing the virtual environment at an overhead angle. In some embodiments, the camera model is not actually displayed in the virtual environment. That is, the camera model is not displayed in the virtual environment displayed on the user interface.

In this embodiment of the present disclosure, different virtual environments correspond to different virtual environment pictures. For example, a virtual environment picture corresponding to the virtual environment (planet) is different from a virtual environment picture corresponding to the virtual environment (space station).

The virtual environment picture includes a virtual object and a non-player character (NPC). The NPC is configured to assist the user-controlled virtual object in accomplishing tasks. In some embodiments, the NPC may be at least one of a person image, an animal image, a plant image, a monster image, and the like. In some embodiments, the NPC may also be landscape images such as mountains and lakes. In some embodiments, the user may control the virtual object to combat with the NPC or attack the NPC so as to accomplish a corresponding task. In some embodiments, a user-controlled virtual character may also communicate with the NPC, and the NPC issues tasks, provides prompt information, sells items, etc. to the user-controlled virtual character.

Step 320: Display a first coordinate axis corresponding to a first virtual environment at a first position in the virtual environment picture, and display a second coordinate axis corresponding to a second virtual environment at a second position in the virtual environment picture, wherein a virtual object is located in the first virtual environment, the second virtual environment is a virtual environment other than the first virtual environment, and the coordinate axes carry markers in the virtual environments, a marker indicating a candidate destination of the virtual object where a task can be accomplished.

In this embodiment of the present disclosure, the virtual environment picture further includes a coordinate axis and a marker on the coordinate axis. The coordinate axis may be displayed on an upper layer of the virtual environment picture. The marker is configured to represent a task in the virtual environment. The user may control the virtual object to move toward the marker to accomplish a corresponding task. Since there are multiple virtual environments in this embodiment of the present disclosure, if the markers existing in the multiple virtual environments are displayed on one coordinate axis, the markers on the coordinate axis may overlap, thereby interfering with the user selection of the markers since some markers are blocked.

In order to avoid the foregoing situation, a first position and a second position are provided in the virtual environment picture. The first position indicates a coordinate axis corresponding to a first virtual environment where a virtual object is currently located, and displaying a marker corresponding to a marker in the first virtual environment on the coordinate axis. The second position indicates a coordinate axis corresponding to the second virtual environment, and displaying a marker corresponding to a marker in the second virtual environment on the coordinate axis. The second virtual environment is a virtual environment other than the first virtual environment. In addition, the markers in the first virtual environment and the second virtual environment are also displayed in the virtual environment picture, which correspond to the markers on the coordinate axis one by one.

In some embodiments, the marker may be a marker marked on a virtual map by the user before the user enters the game, or a marker triggered to be hidden after accomplishing a certain task in a game process. The marker is configured to prompt the user to have a task at a certain position in the virtual environment. The task may be in the form of an item collection task, for example, collecting a certain element, such as a carbon element or a potassium element. The task may also be a combat task, for example, attacking a certain NPC, such as attacking a certain monster. This embodiment of the present disclosure is not limited thereto.

In some embodiments, the tasks and the markers on the coordinate axis are in one-to-one correspondence. That is to say, when the tasks are increased, the markers on the coordinate axis are also increased, and when the tasks are reduced, the markers are also reduced. Different tasks are represented by different markers. The same task is represented by the same marker. Whether the tasks are the same is related to the task content.

In some embodiments, the markers are displayed in the virtual environment picture, and the size of the markers has a positive correlation with the distance between the virtual object and the markers. Exemplarily, as the distance between the virtual object and the markers is larger, the markers displayed in the virtual environment picture are larger. As the distance between the virtual object and the markers is smaller, the markers displayed in the virtual environment picture are smaller.

In some embodiments, the markers may be represented by at least one of color, shape, or a combination of color and shape.

In some embodiments, a coordinate range corresponding to a coordinate axis is determined based on the orientation of the virtual object and a perspective size. Accordingly, markers located within the coordinate range are displayed on the coordinate axis. For example, when the orientation of the virtual object is right north and the perspective size is 120°, the coordinate range corresponding to the coordinate axis is 60° north by west to 60° north by east.

When the orientation of the virtual object is changed, the coordinate range corresponding to the coordinate axis and the markers on the coordinate axis are changed accordingly.

With regard to the first position and the second position, in one embodiment, the first position and the second position display coordinate axes corresponding to specific virtual environments. The first position indicates a coordinate axis corresponding to a virtual environment where the virtual object is currently located. The second position indicates a coordinate axis corresponding to a virtual environment other than the virtual environment where the virtual object is currently located.

In one embodiment, the first position and the second position may be fixed or dynamic in the virtual environment picture, and the relative positions of the first position and the second position may be changed.

In some embodiments, the first position and the second position are fixedly displayed at any one of an upper position, a lower position, a left position, or a right position in the virtual environment picture. The user may set fixed display positions of the first position and the second position before entering the game.

In some embodiments, the first position and the second position may be dynamically displayed at any one of an upper position, a lower position, a left position, or a right position in the virtual environment picture.

In some embodiments, the relative positions of the first position and the second position may be changed. For example, the first position is displayed above the virtual environment picture, and the second position is displayed below the virtual environment picture.

With regard to the first virtual environment and the second virtual environment, the first virtual environment and the second virtual environment are relative in relation to where the virtual object is located. The virtual environment where the virtual object is currently located is the first virtual environment, and the virtual environment other than the virtual environment where the virtual object is currently located is the second virtual environment. Exemplarily, as shown in FIG. 1, in some embodiments, the virtual environment where the virtual object is currently located is the planet 120. At this moment, the planet 120 is the first virtual environment, and the space 110, any other planet 120, and any space station 130 are the second virtual environment. In some embodiments, the virtual environment where the virtual object is currently located is a space station 130. At this moment, the space station 130 is the first virtual environment, and the space 110, any other space station, and any planet 120 are the second virtual environment. In some embodiments, the first virtual environment is the space 110, and any planet 120 and any space station 130 are the second virtual environment.

Exemplarily, as shown in FIG. 4, the first position in the virtual environment picture displays a first coordinate axis 410 for representing a first virtual environment 415 where a virtual object 414 is currently located, and a first marker 412 is displayed on the first coordinate axis 410 for representing a marker existing in the first virtual environment 415. The second position in the virtual environment picture displays a second coordinate axis 411 for representing a second virtual environment (not shown) other than the first virtual environment, and a second marker 413 is displayed on the second coordinate axis 411 for representing a marker existing in the second virtual environment. The markers in the first virtual environment and the second virtual environment are also displayed in the virtual environment picture, which correspond to the markers displayed on the coordinate axis one by one. In addition, the distance between the virtual object and the markers is represented by the sizes of the markers. The markers are exemplified by a first marker 412 and a second marker 413. It can be seen from the first coordinate axis at the first position that the first marker 412 is located in the first virtual environment 415 where the virtual object 414 is currently located. It can be seen from the second coordinate axis at the second position that the second marker 413 is located in the second virtual environment other than the first virtual environment where the virtual object 414 is currently located. The distance between the virtual object and the first marker 412 is less than the distance between the virtual object and the second marker 413. Therefore, the first marker 412 is greater than the second marker 413. The user may take a reasonable policy to control the virtual object 414 to move toward the first marker 412 and the second marker 413 to accomplish the task. For example, the user may control the virtual object 414 to run to the first marker 412 to accomplish the task, and the user may control the virtual object 414 to drive an airship to move toward the second marker 413 to accomplish the task.

Step 330: Update the first coordinate axis and the second coordinate axis as the virtual object moves from the first virtual environment to the second virtual environment (e.g., during a journey of the virtual object moving from the first virtual environment to the second virtual environment).

In this embodiment of the present disclosure, the user controls the virtual object to move between the first virtual environment and the second virtual environment and reach the corresponding markers to accomplish the corresponding tasks according to the coordinate axes displayed at the first position and the second position and the markers on the coordinate axes. At this moment, since the virtual environment where the virtual object is located is changed, the first coordinate axis displayed at the first position and the second coordinate axis displayed at the second position are changed accordingly, thereby updating the first coordinate axis and the second coordinate axis. In addition, the markers on the coordinate axes are updated as the virtual environment where the virtual object is located is changed.

In one embodiment, display states of the first coordinate axis and the second coordinate axis are updated.

In some embodiments, the display state may be at least one of transparency, size, and the like of the coordinate axis, and at least one of transparency, size, and the like of the marker on the coordinate axis.

In another embodiment, display positions of the first coordinate axis and the second coordinate axis are updated.

In some embodiments, when the virtual environment where the virtual object is located is changed, the first coordinate axis displayed at the first position is switched to the second position, and the second coordinate axis displayed at the second position is switched to the first position.

In summary, in this embodiment of the present disclosure, a coordinate axis (first coordinate axis) corresponding to a first virtual environment where a virtual object is located and a marker on the coordinate axis are displayed at a first position in a virtual environment picture, and a coordinate axis (second coordinate axis) corresponding to a second virtual environment and a marker on the coordinate axis are displayed at a second position. The second virtual environment is a virtual environment other than the first virtual environment. The coordinate axes at the first position and the second position are updated as the virtual object moves from the first virtual environment to the second virtual environment. The coordinate axes and the markers of different virtual environments are displayed at the first position and the second position respectively, so as to avoid interference on user determination for the markers due to overlapping of the markers, displayed on a coordinate axis, in all the virtual environments. In addition, a user may also determine specific positions of the markers through the marker on the coordinate axis at the first position and the marker on the coordinate axis at the second position, so as to control, using a reasonable policy, the virtual object to move to the markers to accomplish a task.

In this embodiment of the present disclosure, the quantity of markers on the coordinate axis is related to the quantity of markers in the virtual environment. In one embodiment, when there is no marker in the second virtual environment, there is no marker on the second coordinate axis located at the second position. Therefore, the second coordinate axis is hidden in order to reduce the processing workload of the terminal. In another embodiment, when the quantity of markers in the second virtual environment is large to cause overlapping of the markers on the second coordinate axis located at the second position, the second coordinate axis is hidden in order to avoid interfering with the user determination for the markers on the first coordinate axis located at the first position.

In some embodiments, the terminal displays the second coordinate axis at the second position in the virtual environment picture in response to that the quantity of markers in the second virtual environment is greater than a first quantity threshold and less than a second quantity threshold.

In this embodiment of the present disclosure, the terminal displays the first coordinate axis at the first position in the virtual environment picture. The coordinate axis indicates the virtual environment where the virtual object is currently located, namely, the first virtual environment. Whether the second coordinate axis located at the second position is displayed or not depends on the virtual environment other than the virtual environment where the virtual object is currently located, namely, the quantity of markers in the second virtual environment. In one embodiment, the quantity of markers in the second virtual environment is greater than a first quantity threshold and less than a second quantity threshold, and the second coordinate axis and the markers on the coordinate axis are displayed at the second position in the virtual environment picture. That is to say, the user may view the second coordinate axis and the markers on the coordinate axis located at the second position in the virtual environment picture.

In some embodiments, the first quantity threshold may be 0, 1, or the like. This embodiment of the present disclosure is not limited thereto.

In some embodiments, the second quantity threshold may be 10, 11, 12, or the like. This embodiment of the present disclosure is not limited thereto.

In addition, in order to ensure that the relative positions of the markers in the first virtual environment and the second virtual environment can be accurately determined during the perspective movement of the virtual object, center points of the first coordinate axis and the second coordinate axis are aligned.

With regard to the forms of the first coordinate axis and the second coordinate axis, in one embodiment, the forms of the first coordinate axis and the second coordinate axis are required to be the same. In some embodiments, the first coordinate axis and the second coordinate axis may both be a linear coordinate axis, and the first coordinate axis and the second coordinate axis may both be a curved coordinate axis.

With regard to the lengths of the first coordinate axis and the second coordinate axis, in one embodiment, the length of the first coordinate axis is a first size, the length of the second coordinate axis is a second size, and the first size of the first coordinate axis and the second size of the second coordinate axis may or may not be the same. When the first size of the first coordinate axis and the second size of the second coordinate axis are different, the first size of the first coordinate axis is greater than the second size of the second coordinate axis.

In some embodiments, the first coordinate axis and the second coordinate axis are bilaterally symmetric.

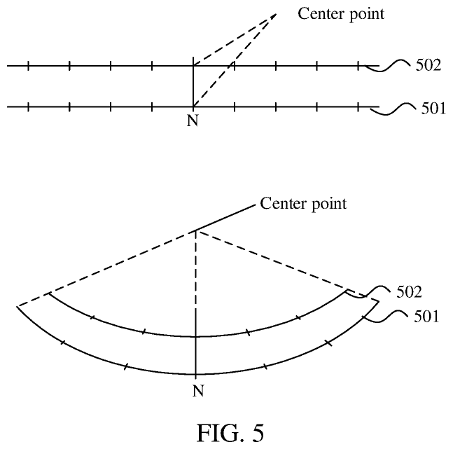

Exemplarily, as shown in FIG. 5, a first coordinate axis 501 and a second coordinate axis 502 are exemplified as a linear coordinate axis or a curved coordinate axis. Center points of the first coordinate axis 501 and the second coordinate axis 502 are aligned. Scales on the first coordinate axis 501 and the second coordinate axis 502 represent the orientation. When the first coordinate axis 501 and the second coordinate axis 502 are the linear coordinate axes, a first size of the first coordinate axis 501 is the same as a second size of the second coordinate axis 502. When the first coordinate axis 501 and the second coordinate axis 502 are the curved coordinate axes, the first size of the first coordinate axis 501 is greater than the second size of the second coordinate axis 502.

In some embodiments, the second coordinate axis is hidden in response to that the quantity of markers in the second virtual environment is less than a first quantity threshold or greater than a second quantity threshold.

In one embodiment, the second coordinate axis is hidden in response to that the quantity of markers in the second virtual environment is less than the first quantity threshold. That is to say, the second coordinate axis is hidden in the absence of markers in the second virtual environment, namely the absence of markers on the second coordinate axis.

In another embodiment, the second coordinate axis is hidden in response to that the quantity of markers in the second virtual environment is greater than the second quantity threshold. That is to say, if the quantity of markers in the second virtual environment is too large, the markers on the second coordinate axis may overlap. In order to avoid interfering with the user determination for the markers on the first coordinate axis, the second coordinate axis is hidden. The coordinate axis is hidden to indicate that the user cannot view the second coordinate axis in the virtual environment picture.

With regard to the manner of hiding the second coordinate axis, in one embodiment, the terminal adjusts the transparency of the second coordinate axis to zero. In another embodiment, the terminal covers the second coordinate axis with a layer to cover the second coordinate axis.

In addition, with regard to the first coordinate axis at the first position, the first coordinate axis at the first position is not hidden regardless of whether a marker exists in the first virtual environment. Since the user may mark a marker in the first virtual environment where the virtual object is currently located at any time in the game process, the first coordinate axis at the first position also indicates the position at which the virtual object is currently located.

In summary, the quantity of markers in the second virtual environment determines to display or hide the second coordinate axis at the second position and the markers on the coordinate axis. On the one hand, the interference on user determination for the markers on the first coordinate axis caused by overlapping of excessive markers on the second coordinate axis is avoided. On the other hand, the processing workload of the terminal is reduced.

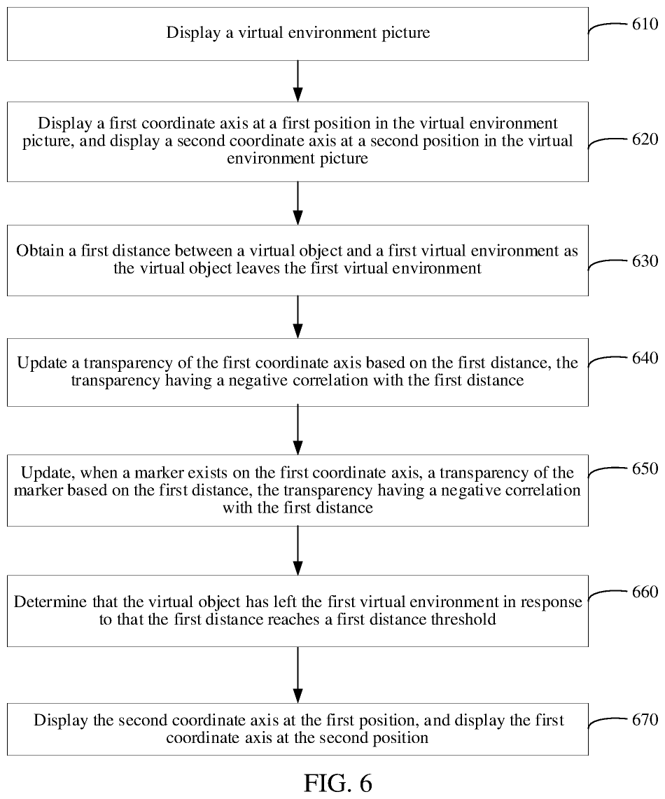

In this embodiment of the present disclosure, the virtual environment may be an entity-type virtual environment or a space-type virtual environment. The virtual object moves from the entity-type virtual environment to the space-type virtual environment or from the space-type virtual environment to the entity-type virtual environment. The update methods for the first coordinate axis and the second coordinate axis are different. In one embodiment, when the virtual object moves from the entity-type virtual environment (first virtual environment) where the virtual object is currently located to the space-type virtual environment (second virtual environment), the display state of the first coordinate axis is updated first. When the virtual object enters the second virtual environment, the display positions of the first coordinate axis and the second coordinate axis are updated. The foregoing coordinate axis display method is described below. FIG. 6 shows a flowchart of a coordinate axis display method applied to virtual environments according to another exemplary embodiment of the present disclosure.

Step 610: Display a virtual environment picture.

Step 610 is similar to step 310, and will not be described in detail in this embodiment of the present disclosure.

Step 620: Display a first coordinate axis at a first position in the virtual environment picture, and display a second coordinate axis at a second position in the virtual environment picture.

Step 620 is similar to step 320, and will not be described in detail in this embodiment of the present disclosure.

Step 630: Obtain a first distance between a virtual object and a first virtual environment as the virtual object leaves the first virtual environment (e.g., during the journey of the virtual object moving from the first virtual environment to the second virtual environment).

In this embodiment of the present disclosure, the first virtual environment is a virtual environment where the virtual object is currently located. The virtual environment is an entity-type virtual environment, such as a planet or a space station. A user may control the virtual object to drive a virtual vehicle away from the first virtual environment. In some embodiments, the virtual vehicle may be an airship, an airplane, or the like. This embodiment of the present disclosure is not limited thereto. In one embodiment, a terminal obtains a distance, namely the first distance, between the virtual object and a reference point in the first virtual environment where the virtual object is located as the virtual object leaves the first virtual environment. The reference point may be a center point of the first virtual environment, or a projection point of the virtual object on the surface of the first virtual environment. The specific position of the reference point is not limited in this embodiment of the present disclosure.

In one embodiment, the terminal obtains the distance between the virtual object and the first virtual environment in real time as the user controls the virtual object to drive the virtual vehicle away from the first virtual environment.

In one embodiment, the terminal periodically obtains the distance between the virtual object and the first virtual environment as the user controls the virtual object to drive the virtual vehicle away from the first virtual environment.

In some embodiments, the period duration may be 10s, 20s, 30s, or the like. This embodiment of the present disclosure is not limited thereto.

Step 640: Update a transparency of the first coordinate axis based on the first distance, the transparency having a negative correlation with the first distance.

In this embodiment of the present disclosure, the virtual environment where the virtual object is currently located is gradually changed as the virtual object moves from the first virtual environment to a second virtual environment. Therefore, the display state of the first coordinate axis at the first position in the virtual environment picture is also changed accordingly. The transparency of the first coordinate axis has a negative correlation with the first distance. That is to say, as the first distance is larger, the transparency of the first coordinate axis is smaller. As the virtual object is closer to the first virtual environment, the transparency of the first coordinate axis is larger. When the transparency is 0, the first coordinate axis is in a hidden state. That is to say, the user cannot view the first coordinate axis in the virtual environment picture. When the transparency is 1, the first coordinate axis is in a display state. That is to say, the user may view the first coordinate axis in the virtual environment picture.

Step 650: Update, when a marker exists on the first coordinate axis (e.g., a task exists at a destination in the first virtual environment), a transparency of the marker based on the first distance, the transparency having a negative correlation with the first distance.

The coordinate axes are used for displaying the markers in the virtual environment. Therefore, when the virtual environment where the virtual object is located is changed, the display states of the markers on the first coordinate axis are changed synchronously with the display state of the first coordinate axis. That is, the transparency of the markers has a negative correlation with the first distance. That is to say, as the virtual object is farther away from the first virtual environment, the transparency of the markers on the first coordinate axis is smaller. As the virtual object is closer to the first virtual environment, the transparency of the markers on the first coordinate axis is larger. When the transparency is 0, the markers on the first coordinate axis are in a hidden state. That is to say, the user cannot view the markers on the first coordinate axis in the virtual environment picture. When the transparency is 1, the markers on the first coordinate axis are in a display state. That is to say, the user may view the markers on the first coordinate axis in the virtual environment picture.

In some embodiments, the transparency of the markers on the first coordinate axis is consistent with the transparency of the first coordinate axis.

Step 660: Determine that the virtual object has left the first virtual environment (e.g., to enter a second virtual environment or to enter an intermediate environment on the journey to the second virtual environment) in response to that the first distance reaches a first distance threshold.

As the virtual object moves from the first virtual environment to the second virtual environment, the terminal obtains the distance between the virtual object and the first virtual environment, namely, the first distance, and determines whether the distance reaches the first distance threshold. In one embodiment, it is determined that the virtual object has left the first virtual environment in response to that the first distance reaches the first distance threshold. In another embodiment, the terminal determines that the virtual object is still in the first virtual environment in response to that the first distance does not reach the first distance threshold.

In some embodiments, the first distance threshold may be 1300 km, 1400 km, 1600 km, or the like. This embodiment of the present disclosure is not limited thereto.

Step 670: Display the second coordinate axis at the first position, and display the first coordinate axis at the second position.

In this embodiment of the present disclosure, the first position indicates the coordinate axis of the virtual environment where the virtual object is currently located. Since the virtual environment where the virtual object is currently located is changed from the first virtual environment to the second virtual environment, the second coordinate axis and the markers on the coordinate axis (the markers in the second virtual environment) are displayed at the first position. The second position indicates the virtual environment other than the virtual environment where the virtual object is currently located. The virtual environment other than the virtual environment where the virtual object is currently located is changed from the second virtual environment to the first virtual environment. Therefore, the first coordinate axis and the markers on the coordinate axis (the markers in the first virtual environment) are displayed at the second position.

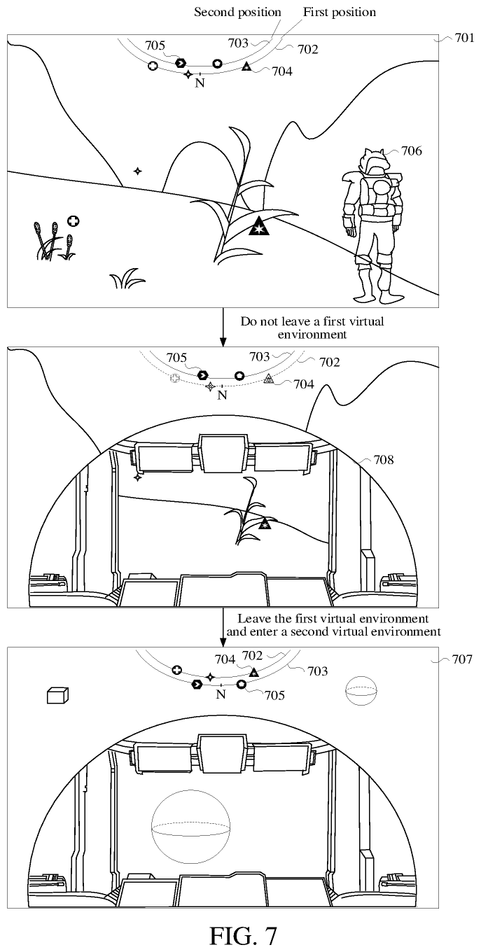

Exemplarily, as shown in FIG. 7, the coordinate axis display method applied to virtual environments will be described by taking the first virtual environment as a planet and the second virtual environment as a space. A virtual object 706 is currently located in a planet 701, and the virtual object 706 drives an airship 708 to move from the planet 701 to a space 707. A first coordinate axis 702 and a first marker 704 (marker in the planet 701) on the first coordinate axis are displayed at a first position in a virtual environment picture, and a second coordinate axis 703 and a second marker 705 (marker in the space 707) on the second coordinate axis are displayed at a second position. As the virtual object 706 drives the airship 708 off the planet 701, the transparency of the first coordinate axis 702 and the first marker 704 is reduced as the distance between the virtual object 706 and the planet 701 is increased. When the virtual object 706 enters the space 707, display positions of the first coordinate axis 702 and the second coordinate axis 703 are changed, the second coordinate axis 703 and the second marker 705 are displayed at the first position, and the first coordinate axis 702 and the first marker 704 are displayed at the second position.

In summary, as a virtual object moves from a first virtual environment (entity-type virtual environment) to a second virtual environment (space-type virtual environment), the transparency of a first coordinate axis is reduced as the distance between the virtual object and the first virtual environment is increased, and when the virtual object enters the second virtual environment, display positions of the first coordinate axis and the second coordinate axis are changed. When the virtual environment where the virtual object is located is changed, the coordinate axes at the first position and the second position and the markers on the coordinate axes are also changed, thereby not affecting the user determination for the markers.

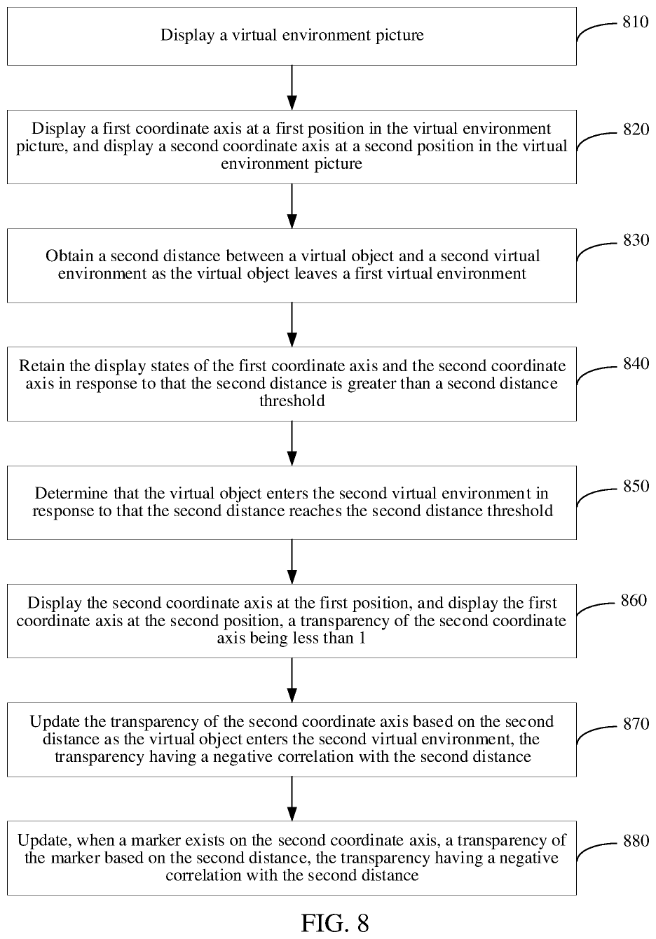

In another embodiment, as the virtual object moves from the space-type virtual environment (first virtual environment) where the virtual object is currently located to the entity-type virtual environment (second virtual environment), the display states of the first coordinate axis and the second coordinate axis are retained when the virtual object does not enter the second virtual environment. When the virtual object enters the second virtual environment, the display positions of the first coordinate axis and the second coordinate axis are updated, and the display state of the second coordinate axis is updated. The foregoing coordinate axis display method is described below. FIG. 8 shows a flowchart of a coordinate axis display method applied to virtual environments according to another exemplary embodiment of the present disclosure.

Step 810: Display a virtual environment picture.

Step 810 is similar to step 310, and will not be described in detail in this embodiment of the present disclosure.

Step 820: Display a first coordinate axis at a first position in the virtual environment picture, and display a second coordinate axis at a second position in the virtual environment picture.

Step 820 is similar to step 320, and will not be described in detail in this embodiment of the present disclosure.

Step 830: Obtain a second distance between a virtual object and a second virtual environment as the virtual object leaves a first virtual environment.

In this embodiment of the present disclosure, the first virtual environment is a space-type virtual environment, and the second virtual environment is an entity-type virtual environment. In one example, since the virtual object does not have a reference point in the space-type virtual environment, a terminal cannot obtain the distance between the virtual object and the first virtual environment. And a reference point exists in the entity-type virtual environment, such as a planet or a space station. Therefore, as the virtual object leaves the first virtual environment, the terminal obtains a distance between the virtual object and the reference point thereof in the second virtual environment, namely, a second distance.

In one embodiment, the terminal obtains the second distance between the virtual object and the second virtual environment in real time as the user controls the virtual object to drive the virtual vehicle away from the first virtual environment. The second distance may be the distance between the virtual object and the reference point in the second virtual environment. The reference point may be a center point of the second virtual environment, or a projection point of the virtual object on the surface of the second virtual environment. The specific position of the reference point is not limited in this embodiment of the present disclosure.

In one embodiment, the terminal periodically obtains the distance between the virtual object and the first virtual environment as the user controls the virtual object to drive the virtual vehicle away from the second virtual environment.

In some embodiments, the period duration may be 10s, 20s, 30s, or the like. This embodiment of the present disclosure is not limited thereto.

Step 840: Retain the display states of the first coordinate axis and the second coordinate axis in response to that the second distance is greater than a second distance threshold.

In this embodiment of the present disclosure, the second distance is greater than the second distance threshold, indicating that the virtual object still does not leave the first virtual environment. Therefore, in one embodiment, the positions of the first coordinate axis and the second coordinate axis remain unchanged. That is to say, the first coordinate axis is located at the first position in the virtual environment picture for representing the first virtual environment where the virtual object is currently located, and the second coordinate axis is located at the second position in the virtual environment picture for representing the second virtual environment.

In some embodiments, the terminal retains the transparency of the first coordinate axis and the second coordinate axis unchanged before leaving the first virtual environment.

In addition, the display states of the markers on the first coordinate axis and the second coordinate axis are also unchanged, that is, the transparency is unchanged.

Step 850: Determine that the virtual object enters the second virtual environment (e.g., from the first virtual environment or from an intermediate environment on the journey from the first environment to the second virtual environment) in response to that the second distance reaches the second distance threshold.

As the virtual object moves from the first virtual environment to the second virtual environment, the terminal obtains the distance between the virtual object and the second virtual environment, namely, the second distance, and determines whether the distance reaches the second distance threshold. In one embodiment, it is determined that the virtual object enters the second virtual environment in response to that the second distance reaches (is less than or equal to) the second distance threshold. In another embodiment, it is determined that the virtual object is still in the first virtual environment in response to that the second distance does not reach the second distance threshold.

In some embodiments, the second distance threshold may be 1300 km, 1400 km, 1600 km, or the like. This embodiment of the present disclosure is not limited thereto.

Step 860: Display the second coordinate axis at the first position, and display the first coordinate axis at the second position, a transparency of the second coordinate axis being less than 1.

In this embodiment of the present disclosure, the first position indicates the coordinate axis of the virtual environment where the virtual object is currently located. Since the virtual environment where the virtual object is currently located is changed from the first virtual environment to the second virtual environment, the second coordinate axis and the markers on the coordinate axis (the markers in the second virtual environment) are displayed at the first position. The second position indicates the virtual environment other than the virtual environment where the virtual object is currently located. The virtual environment other than the virtual environment where the virtual object is currently located is changed from the second virtual environment to the first virtual environment. Therefore, the first coordinate axis and the markers on the coordinate axis (the markers in the first virtual environment) are displayed at the second position.

In addition, in this embodiment of the present disclosure, when the virtual object enters the second virtual environment, the transparency of the second coordinate axis is changed as the second distance is changed. Since the second virtual environment is an entity-type virtual environment, when the virtual object does not reach a landing point of the virtual object in the second virtual environment, the transparency of the second coordinate axis is less than 1. That is to say, the second coordinate axis viewed by the user in the virtual environment picture will not be completely displayed, and is still in a semi-transparent state.

Step 870: Update the transparency of the second coordinate axis based on the second distance as the virtual object enters the second virtual environment (e.g., during the journey of the virtual object moving from the first virtual environment to the second virtual environment), the transparency having a negative correlation with the second distance.

In this embodiment of the present disclosure, as the virtual object enters the second virtual environment and the virtual object reaches the landing point thereof in the second virtual environment, the distance between the virtual object and the second virtual environment is gradually reduced, and the display state of the second coordinate axis is also changed as the second distance is changed. The transparency of the second coordinate axis has a negative correlation with the second distance. That is to say, as the virtual object is farther away from the second virtual environment, the transparency of the second coordinate axis is smaller. As the virtual object is closer to the second virtual environment, the transparency of the second coordinate axis is larger. When the transparency is 0, the second coordinate axis is in a hidden state. That is to say, the user cannot view the second coordinate axis in the virtual environment picture. When the transparency is 1, the second coordinate axis is in a display state. That is to say, the user may view the second coordinate axis in the virtual environment picture.

When the distance between the virtual object and the second virtual environment is 0, the second distance is 0. That is to say, when the virtual object is located at the landing point of the second virtual environment, the transparency of the second coordinate axis is 1, and the second coordinate axis is in a display state.

Step 880: Update, when a marker exists on the second coordinate axis (e.g., a task exists at a destination in the second virtual environment), a transparency of the marker based on the second distance, the transparency having a negative correlation with the second distance.

The coordinate axes are used for displaying the markers in the virtual environment. The display states of the markers on the second coordinate axis are changed synchronously with the display state of the second coordinate axis. That is, the transparency of the markers has a negative correlation with the second distance. That is to say, as the virtual object is farther away from the second virtual environment, the transparency of the markers on the second coordinate axis is smaller. As the virtual object is closer to the second virtual environment, the transparency of the markers on the second coordinate axis is large. When the transparency is 0, the markers on the second coordinate axis are in a hidden state. That is to say, the user cannot view the markers on the second coordinate axis in the virtual environment picture. When the transparency is 1, the markers on the second coordinate axis are in a display state. That is to say, the user may view the markers on the second coordinate axis in the virtual environment picture.

When the distance between the virtual object and the second virtual environment is 0, the second distance is 0. That is to say, when the virtual object is located at the landing point of the second virtual environment, the transparency of the markers on the second coordinate axis is 1, and the markers on the second coordinate axis are in a display state.

In some embodiments, the transparency of the markers on the second coordinate axis is consistent with the transparency of the second coordinate axis.

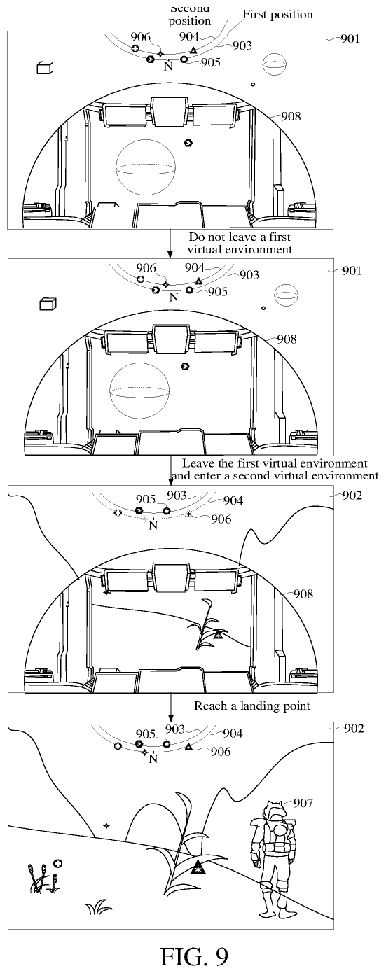

Exemplarily, as shown in FIG. 9, the coordinate axis display method applied to virtual environments will be described by taking the first virtual environment as a space and the second virtual environment as a planet. A virtual object 907 is currently located in a space 901, and the virtual object 907 drives an airship 908 to move from the space 901 to a planet 902. A first coordinate axis 903 and a first marker 905 (marker in the space 901) on the coordinate axis are displayed at a first position in a virtual environment picture, and a second coordinate axis 904 and a second marker 906 (marker in the planet 902) on the coordinate axis are displayed at a second position. When the virtual object 907 does not leave the space 901, the first coordinate axis 903 and the first marker 905 on the first coordinate axis and the second coordinate axis 904 and the second marker 906 on the second coordinate axis remain unchanged. When the virtual object 907 enters the planet 902 from the space 901, display positions of the first coordinate axis 903 and the second coordinate axis 904 are changed, the second coordinate axis 904 and the second marker 906 are displayed at the first position, and the first coordinate axis 903 and the first marker 905 are displayed at the second position. The transparency of the second coordinate axis 904 and the second marker 906 is increased as the distance between the virtual object 907 and the planet 902 is reduced. When the virtual object 907 reaches a landing point in the planet 902, the transparency of the second coordinate axis 904 and the second marker 906 is 1.

In summary, in this embodiment of the present disclosure, when a virtual object moves from a first virtual environment (space-type virtual environment) to a second virtual environment (entity-type virtual environment), the virtual object does not leave the first virtual environment, and display states of a first coordinate axis and a second coordinate axis are retained. The virtual object enters the second virtual environment, display positions of the first coordinate axis and the second coordinate axis are changed, and the transparency of the second coordinate axis is increased as the distance between the virtual object and the second coordinate axis is reduced. When the virtual environment where the virtual object is located is changed, the coordinate axes at the first position and the second position and the markers on the coordinate axes are also changed, thereby not affecting the user determination for the markers.

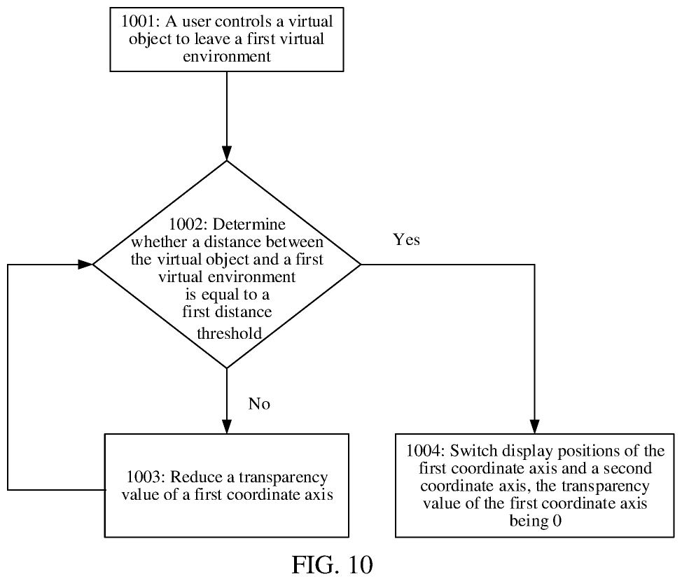

In connection with the foregoing embodiments, a schematic example is described with the first virtual environment being a planet and the second virtual environment being a space. A flowchart of a coordinate axis display method applied to virtual environments is shown in FIG. 10:

Step 1001: A user controls a virtual object to leave a first virtual environment.

Step 1002: Determine whether a distance between the virtual object and the first virtual environment is equal to a first distance threshold. If no, step 1003 is performed. If yes, step 1004 is performed.

Step 1003: Reduce a transparency of a first coordinate axis.

Step 1004: Update display positions of the first coordinate axis and a second coordinate axis, the transparency of the first coordinate axis being 0.

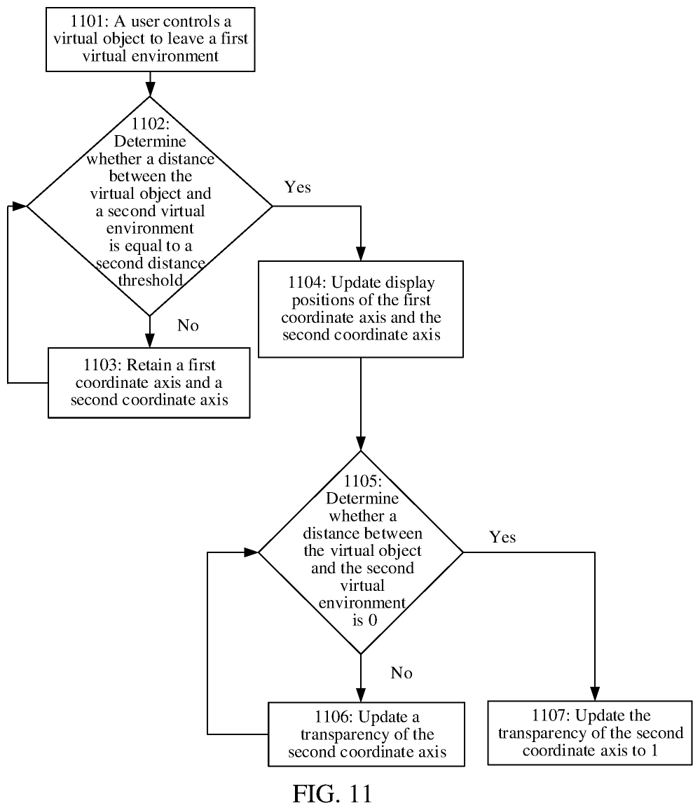

In connection with the foregoing embodiments, another schematic example is described with the first virtual environment being a space and the second virtual environment being a planet. A flowchart of a coordinate axis display method applied to virtual environments is shown in FIG. 11:

Step 1101: A user controls a virtual object to leave a first virtual environment.

Step 1102: Determine whether a distance between the virtual object and a second virtual environment is equal to a second distance threshold. If no, step 1103 is performed. If yes, step 1104 is performed.

Step 1103: Retain a first coordinate axis and a second coordinate axis.

Step 1104: Update display positions of the first coordinate axis and the second coordinate axis.

Step 1105: Determine whether a distance between the virtual object and the second virtual environment is 0. If no, step 1106 is performed. If yes, step 1107 is performed.

Step 1106: Update a transparency of the second coordinate axis.

Step 1107: Update the transparency of the second coordinate axis to 1.

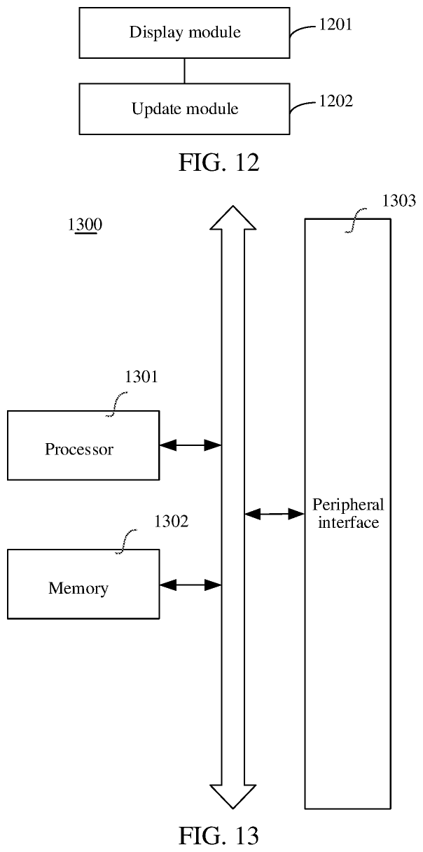

FIG. 12 is a structural block diagram of a coordinate axis display apparatus applied to virtual environments according to an exemplary embodiment of the present disclosure. The apparatus includes:

a display module 1201, configured to display a virtual environment picture,

the display module 1201 being configured to display a first coordinate axis at a first position in the virtual environment picture, and display a second coordinate axis at a second position in the virtual environment picture, the first position indicating a coordinate axis corresponding to a first virtual environment where a virtual object is located, the second position indicating a coordinate axis corresponding to a second virtual environment, the second virtual environment being a virtual environment other than the first virtual environment, and the coordinate axes indicating markers in the virtual environments; and

an update module 1202, configured to update the first coordinate axis and the second coordinate axis as the virtual object moves from the first virtual environment to the second virtual environment.

In some embodiments, the first virtual environment is an entity-type virtual environment, and the second virtual environment is a space-type virtual environment. The update module 1202 includes:

a first update unit, configured to update a display state of the first coordinate axis as the virtual object leaves the first virtual environment; and

a second update unit, configured to update display positions of the first coordinate axis and the second coordinate axis in response to that the virtual object enters the second virtual environment.

In some embodiments, the first update unit is configured to:

obtain a first distance between the virtual object and the first virtual environment as the virtual object leaves the first virtual environment; and

update a transparency of the first coordinate axis based on the first distance, the transparency having a negative correlation with the first distance.

In some embodiments, the update module 1202 further includes:

a third update unit, configured to:

update, when a marker exists on the first coordinate axis, a transparency of the marker based on the first distance, the transparency having a negative correlation with the first distance.

In some embodiments, the second update unit is configured to:

determine that the virtual object has left the first virtual environment in response to that a first distance between the virtual object and the first virtual environment reaches a first distance threshold; and

display the second coordinate axis at the first position, and display the first coordinate axis at the second position.

In some embodiments, the first virtual environment is a space-type virtual environment, and the second virtual environment is an entity-type virtual environment. The update module 1202 includes:

a retention unit, configured to:

retain display states of the first coordinate axis and the second coordinate axis as the virtual object leaves the first virtual environment;

a fourth update unit, configured to update display positions of the first coordinate axis and the second coordinate axis in response to that the virtual object enters the second virtual environment; and

a fifth update unit, configured to update the display state of the second coordinate axis as the virtual object enters the second virtual environment.

In some embodiments, the retention unit is configured to:

obtain a second distance between the virtual object and the second virtual environment as the virtual object leaves the first virtual environment; and

retain the display states of the first coordinate axis and the second coordinate axis in response to that the second distance is greater than a second distance threshold.

In some embodiments, the fourth update unit is configured to:

determine that the virtual object enters the second virtual environment in response to that the second distance reaches the second distance threshold; and

display the second coordinate axis at the first position, and display the first coordinate axis at the second position.

In some embodiments, the fifth update unit is configured to:

update a transparency of the second coordinate axis based on a second distance between the virtual object and the second virtual environment as the virtual object enters the second virtual environment, the transparency having a negative correlation with the second distance.

In some embodiments, the fifth update unit is configured to:

update, when the second coordinate axis carries/hosts a marker, a transparency of the marker based on the second distance, the transparency having a negative correlation with the second distance.

In some embodiments, the display module 1201 is configured to:

display the second coordinate axis at the second position in the virtual environment picture in response to that the quantity of markers in the second virtual environment is greater than a first quantity threshold and less than a second quantity threshold.

In some embodiments, the apparatus further includes a hiding module, configured to:

hide the second coordinate axis in response to that the quantity of markers in the second virtual environment is less than the quantity threshold or greater than the second quantity threshold.

In some embodiments, the coordinate axis displayed at the first position is a first size, the coordinate axis displayed at the second position is a second size, and center points of the coordinate axes displayed at the first position and the second position are aligned.

The first size is equal to the second size in response to that the coordinate axes displayed at the first position and the second position are linear coordinate axes.

The first size is greater than the second size in response to that the coordinate axes displayed at the first position and the second position are curved coordinate axes.

FIG. 13 is a structural block diagram of a terminal 1300 according to an exemplary embodiment of the present disclosure. The terminal 1300 may be a portable mobile terminal, such as a smartphone, a tablet personal computer, a MP3 player, or a MP4 player. The terminal 1300 may also be referred to as a user equipment, a portable terminal, or another name.

Generally, the terminal 1300 includes: a processor 1301 and a memory 1302.

The processor 1301 may include one or more processing cores, such as a 4-core processor or an 8-core processor. The processor 1301 may be implemented in at least one hardware form of a digital signal processor (DSP), a field-programmable gate array (FPGA), and a programmable logic array (PLA). The processor 1301 may further include a main processor and a co-processor. The main processor is a processor for processing data in a wake-up state, and is also referred to as a central processing unit (CPU). The co-processor is a low-power processor for processing data in a standby state. In some embodiments, the processor 1301 may be integrated with a graphics processing unit (GPU). The GPU is responsible for rendering and drawing content to be displayed by a display screen. In some embodiments, the processor 1301 may further include an artificial intelligence (AI) processor. The AI processor is configured to process computing operations related to machine learning.

The memory 1302 may include one or more computer-readable storage media. The computer-readable storage media may be tangible and non-transitory. The memory 1302 may further include a high-speed random access memory and a nonvolatile memory, for example, one or more disk storage devices or flash storage devices. In some embodiments, the non-transitory computer-readable storage medium in the memory 1302 is configured to store at least one instruction. The at least one instruction is used for execution by the processor 1301 to implement the method according to the foregoing embodiment of the present disclosure.

In some embodiments, the terminal 1300 may further include: a peripheral interface 1303 and at least one peripheral. For example, the peripheral includes: a radio frequency circuit, a touch display screen, a power supply, and the like.

The peripheral interface 1303 may be configured to connect the at least one peripheral related to I/O to the processor 1301 and the memory 1302. In some embodiments, the processor 1301, the memory 1302, and the peripheral interface 1303 are integrated on the same chip or circuit board. In some other embodiments, any one or two of the processor 1301, the memory 1302 and the peripheral interface 1303 may be implemented on a separate chip or circuit board. This is not limited by this embodiment.

It is to be understood by a person skilled in the art that the structure shown in FIG. 13 is not limiting of the terminal 1300 and may include more or fewer assemblies than illustrated, or some assemblies may be combined, or different assembly arrangements may be employed.

Embodiments of the present disclosure also provide a computer-readable storage medium. The computer-readable storage medium stores at least one instruction. The at least one instruction is loaded and executed by a processor to implement the coordinate axis display method applied to virtual environments according to the various embodiments described above.

According to one aspect of the present disclosure, a computer program product is provided. The computer program product includes a computer instruction. The computer instruction is stored in a computer-readable storage medium. A processor of a terminal reads the computer instruction from the computer-readable storage medium. The processor executes the computer instruction, whereby the terminal performs the coordinate axis display method applied to virtual environments according to the various example implementations in the foregoing aspect.

A person skilled in the art may be aware that in the foregoing one or more examples, functions described in the embodiments of the present disclosure may be implemented by hardware, software, firmware, or any combination thereof. When implemented by using software, the functions may be stored in the computer-readable medium or may be used as one or more instructions or code in the computer-readable medium for transmission. The computer-readable medium includes a computer storage medium and a communication medium. The communication medium includes any medium that enables a computer program to be transmitted from one place to another. The storage medium may be any available medium accessible to a general-purpose or dedicated computer.

The foregoing descriptions are merely example embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A coordinate axis display method applied to virtual environments, performed by a terminal, the method comprising:
displaying a virtual environment picture;
displaying a first coordinate axis corresponding to a first virtual environment at a first position in the virtual environment picture, and displaying a second coordinate axis corresponding to a second virtual environment at a second position in the virtual environment picture, wherein a virtual object is located in the first virtual environment, the second virtual environment is a virtual environment other than the first virtual environment, and the coordinate axes carry markers in the virtual environments, a marker indicating a candidate destination of the virtual object where a task can be accomplished; and
updating the first coordinate axis and the second coordinate axis as the virtual object moves from the first virtual environment to the second virtual environment.

2. The method according to claim 1, wherein the first virtual environment is an entity-type virtual environment, and the second virtual environment is a space-type virtual environment; and
the updating the first coordinate axis and the second coordinate axis as the virtual object moves from the first virtual environment to the second virtual environment comprises:
updating a display state of the first coordinate axis as the virtual object leaves the first virtual environment; and
updating display positions of the first coordinate axis and the second coordinate axis in response to that the virtual object enters the second virtual environment.

3. The method according to claim 2, wherein the updating a display state of the first coordinate axis as the virtual object leaves the first virtual environment comprises:
obtaining a first distance between the virtual object and the first virtual environment as the virtual object leaves the first virtual environment; and
updating a transparency of the first coordinate axis based on the first distance, the transparency having a negative correlation with the first distance.

4. The method according to claim 3, wherein the updating a display state of the first coordinate axis as the virtual object leaves the first virtual environment further comprises:
updating, when a marker exists on the first coordinate axis, a transparency of the marker based on the first distance, the transparency having a negative correlation with the first distance.

5. The method according to claim 2, wherein the updating display positions of the first coordinate axis and the second coordinate axis in response to that the virtual object enters the second virtual environment comprises:
determining that the virtual object has left the first virtual environment in response to that a first distance between the virtual object and the first virtual environment reaches a first distance threshold; and
displaying the second coordinate axis at the first position, and displaying the first coordinate axis at the second position.

6. The method according to claim 1, wherein the first virtual environment is a space-type virtual environment, and the second virtual environment is an entity-type virtual environment; and
the updating the first coordinate axis and the second coordinate axis as the virtual object moves from the first virtual environment to the second virtual environment comprises:
retaining display states of the first coordinate axis and the second coordinate axis as the virtual object leaves the first virtual environment;
updating display positions of the first coordinate axis and the second coordinate axis in response to that the virtual object enters the second virtual environment; and
updating the display state of the second coordinate axis as the virtual object enters the second virtual environment.

7. The method according to claim 6, wherein the retaining display states of the first coordinate axis and the second coordinate axis as the virtual object leaves the first virtual environment comprises:
obtaining a second distance between the virtual object and the second virtual environment as the virtual object leaves the first virtual environment; and
retaining the display states of the first coordinate axis and the second coordinate axis in response to that the second distance is greater than a second distance threshold.

8. The method according to claim 7, wherein the updating display positions of the first coordinate axis and the second coordinate axis in response to that the virtual object enters the second virtual environment comprises:
determining that the virtual object enters the second virtual environment in response to that the second distance reaches the second distance threshold; and
displaying the second coordinate axis at the first position, and displaying the first coordinate axis at the second position.

9. The method according to claim 6, wherein the updating the display state of the second coordinate axis as the virtual object enters the second virtual environment comprises:
updating a transparency of the second coordinate axis based on a second distance between the virtual object and the second virtual environment as the virtual object enters the second virtual environment, the transparency having a negative correlation with the second distance.

10. The method according to claim 9, wherein the updating the display state of the second coordinate axis as the virtual object enters the second virtual environment further comprises:
updating, when a marker exists on the second coordinate axis, a transparency of the marker based on the second distance, the transparency having a negative correlation with the second distance.

11. The method according to claim 1, wherein the displaying a second coordinate axis at a second position in the virtual environment picture comprises:
displaying the second coordinate axis at the second position in the virtual environment picture in response to that a quantity of markers in the second virtual environment is greater than a first quantity threshold and less than a second quantity threshold.

12. The method according to claim 1, further comprising:
hiding the second coordinate axis in response to that a quantity of markers in the second virtual environment is less than a first quantity threshold or greater than a second quantity threshold.

13. The method according to claim 1, wherein the coordinate axis displayed at the first position has a first size, the coordinate axis displayed at the second position has a second size, and center points of the coordinate axes displayed at the first position and the second position are aligned,
the first size equals the second size in response to that the coordinate axes displayed at the first position and the second position are linear coordinate axes; and
the first size is greater than the second size in response to that the coordinate axes displayed at the first position and the second position are curved coordinate axes.

14. A coordinate axis display apparatus applied to virtual environments, the apparatus comprising:
at least one processor and at least one memory, the at least one memory storing at least one instruction, and the at least one instruction being loaded and executed by the at least one processor to implement:
displaying a virtual environment picture;
displaying a first coordinate axis corresponding to a first virtual environment at a first position in the virtual environment picture, and displaying a second coordinate axis corresponding to a second virtual environment at a second position in the virtual environment picture, wherein a virtual object is located in the first virtual environment, the second virtual environment is a virtual environment other than the first virtual environment, and the coordinate axes carry markers in the virtual environments, a marker indicating a candidate destination of the virtual object where a task can be accomplished; and
updating the first coordinate axis and the second coordinate axis as the virtual object moves from the first virtual environment to the second virtual environment.

15. The apparatus according to claim 14, wherein the first virtual environment is an entity-type virtual environment, and the second virtual environment is a space-type virtual environment; and
the updating the first coordinate axis and the second coordinate axis as the virtual object moves from the first virtual environment to the second virtual environment comprises:
updating a display state of the first coordinate axis as the virtual object leaves the first virtual environment; and
updating display positions of the first coordinate axis and the second coordinate axis in response to that the virtual object enters the second virtual environment.

16. The apparatus according to claim 15, wherein the updating a display state of the first coordinate axis as the virtual object leaves the first virtual environment comprises:
obtaining a first distance between the virtual object and the first virtual environment as the virtual object leaves the first virtual environment; and
updating a transparency of the first coordinate axis based on the first distance, the transparency having a negative correlation with the first distance.

17. The apparatus according to claim 16, wherein the updating a display state of the first coordinate axis as the virtual object leaves the first virtual environment further comprises:
updating, when a marker exists on the first coordinate axis, a transparency of the marker based on the first distance, the transparency having a negative correlation with the first distance.

18. The apparatus according to claim 15, wherein the updating display positions of the first coordinate axis and the second coordinate axis in response to that the virtual object enters the second virtual environment comprises:
determining that the virtual object has left the first virtual environment in response to that a first distance between the virtual object and the first virtual environment reaches a first distance threshold; and
displaying the second coordinate axis at the first position, and displaying the first coordinate axis at the second position.

19. The apparatus according to claim 14, wherein the first virtual environment is a space-type virtual environment, and the second virtual environment is an entity-type virtual environment; and
the updating the first coordinate axis and the second coordinate axis as the virtual object moves from the first virtual environment to the second virtual environment comprises:
retaining display states of the first coordinate axis and the second coordinate axis as the virtual object leaves the first virtual environment;
updating display positions of the first coordinate axis and the second coordinate axis in response to that the virtual object enters the second virtual environment; and
updating the display state of the second coordinate axis as the virtual object enters the second virtual environment.

20. A non-transitory computer-readable storage medium, storing at least one instruction, and the at least one instruction being loaded and executed by at least one processor to implement:
displaying a virtual environment picture;
displaying a first coordinate axis corresponding to a first virtual environment at a first position in the virtual environment picture, and displaying a second coordinate axis corresponding to a second virtual environment at a second position in the virtual environment picture, wherein a virtual object is located in the first virtual environment, the second virtual environment is a virtual environment other than the first virtual environment, and the coordinate axes carry markers in the virtual environments, a marker indicating a candidate destination of the virtual object where a task can be accomplished; and
updating the first coordinate axis and the second coordinate axis as the virtual object moves from the first virtual environment to the second virtual environment.
